(19) United States
(12) Patent Application Publication
(10) Pub. No.: US 2022/0019783 A1
(43) Pub. Date: Jan. 20, 2022

(54) METHOD FOR PROCESSING A NOTE PAGE OF A NOTEBOOK, COMPUTER DEVICE AND STORAGE MEDIUM

(71) Applicants: ZHANGYUE TECHNOLOGY CO., LTD, Beijing (CN); SHENZHEN ZHANGYUE TECHNOLOGY CO., LTD, Shenzhen (CN)

(72) Inventor: Chao CHENG, Beijing (CN)

(21) Appl. No.: 17/296,161

(22) PCT Filed: Nov. 26, 2019
(86) PCT No.: PCT/CN2019/121012

§ 371 Date: May 21, 2021

(30) Foreign Application Priority Data
Dec. 5, 2018 (CN) 201811482117.2

(51) Int. Cl. G06K 9/00; G06F 3/0484; G06F 3/0481; G06F 40/205

(52) U.S. Cl. CPC G06K 9/00436; G06F 3/04842; G06K 9/00463; G06F 40/205; G06F 3/0481

(57) ABSTRACT

The present disclosure relates to a method for processing a note page of a notebook, a computer device and a storage medium. The method includes: acquiring a note page identification of the note page selected from the original notebook; reading a note page configuration file corresponding to the note page identification; parsing the note page configuration file to obtain the handwritten contents of the note page corresponding to the note page identification; creating a new notebook based on the handwritten contents.

### CROSS REFERENCE TO RELATED APPLICATIONS

This application claims priority to Chinese Patent Application No. 2018114821172, titled “Method for Processing a Note Page of a Notebook, Computer Device and Storage Medium”, filed on Dec. 5, 2018 with the State Intellectual Property Office of People's Republic of China, the entire contents of which are incorporated herein by reference.

### TECHNICAL FIELD

The present disclosure relates to the field of computer technology, and in particular to a method for processing a note page of a notebook, a computer device and a storage medium.

### BACKGROUD

With the development of computer technology, there are various readers through which users can read various electronic books. As users require higher reading performance, a note-taking function has been added in traditional readers. Users can take notes in a note page of the readers, such as drawing lines and writing.

The current ink screen reader is equipped with an electromagnetic board arranged inside the reader and an electromagnetic pen used with the reader. Users can write any content on the screen of the reader using the electromagnetic pen, such as writing, marking, drawing, etc., the experience of which is similar to that of writing contents on a paper medium. The contents written with the electromagnetic pen are also referred to as handwritten notes or handwriting.

Usually the contents of handwriting are saved by page. The reader saves, in one notebook, user's notes on the respective read pages of one electronic book. For example, the user took notes for the contents of 6 pages in the electronic book “Count of Monte Cristo”, respectively, and in the corresponding notebook, 6 pages of notes were saved. When the note pages in the notebook need to be processed, the entire notebook needs to be processed. For example, the entire notebook can only be shared when a note page in a certain electronic book needs to be shared.

### SUMMARY

On this basis, it is necessary to provide a method for processing a note page of a notebook, a computer device and a storage medium for the current problem of needing to process the entire notebook when a note page in the notebook needs to be processed.

A method for processing a note page of a notebook is provided, including:

acquiring a note page identification of the note page selected from an original notebook;

reading a note page configuration file corresponding to the note page identification;

parsing the note page configuration file to obtain handwritten contents of the note page corresponding to the note page identification; and

creating a new notebook based on the handwritten contents.

A computer device is provided, including a memory, in which a computer program is stored, and a processor, the computer program, when executed by the processor, implementing the following steps:

acquiring a note page identification of the note page selected from an original notebook;

reading a note page configuration file corresponding to the note page identification;

parsing the note page configuration file to obtain handwritten contents of the note page corresponding to the note page identification; and

creating a new notebook based on the handwritten contents.

A non-volatile computer-readable storage medium is provided, on which a computer program is stored, when executed by the processor, implementing the following steps:

acquiring a note page identification of the note page selected from an original notebook;

reading a note page configuration file corresponding to the note page identification;

parsing the note page configuration file to obtain handwritten contents of the note page corresponding to the note page identification; and

creating a new notebook based on the handwritten contents.

A computer program product including the computer program stored on the above non-volatile computer-readable storage medium.

In the method for processing a note page of a notebook, the computer device and the storage medium described above, the note page configuration file corresponding to the note page identification of the selected note page in the original notebook is read, the note page configuration file is parsed to obtain the handwritten contents of the note page corresponding to the note page identification, and a new notebook is created according to the contents. By using the solution of the present disclosure, part of the note pages in the notebook can be extracted, and a new notebook can be generated separately, which realizes the processing of part of the note pages of the notebook.

### BRIEF DESCRIPTION OF THE DRAWINGS

FIG. 1 is an internal structure diagram of a computer device in one embodiment;

FIG. 2 is a schematic diagram of a handwriting tablet in one embodiment;

FIG. 3 is a schematic flowchart of a method for processing a note page of a notebook in one embodiment;

FIG. 4 is a schematic flowchart of a method for processing a note page of a notebook in another embodiment.

### DETAILED DESCRIPTION

In order to make objects, technical solutions, and advantages of the present disclosure clearer, the present disclosure will be further described in detail in connection with the accompanying drawings and embodiments in the following. It should be appreciated that the specific embodiments described herein are only used to explain the present disclosure, but not used to limit the present disclosure.

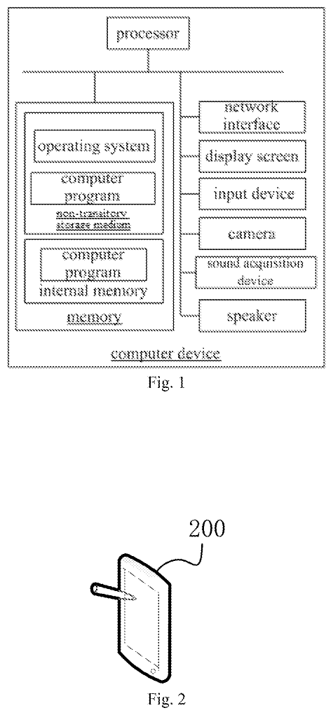

The method for processing a note page of a notebook provided by the embodiments of the present disclosure can be applied to a computer device as shown in FIG. 1. The computer device may be a terminal, and the computer device includes a memory, a processor, a network interface, a display screen, and an input device. A computer program is stored in the memory, and when executed by the processor, can implement the method for processing a note page of a notebook provided by the embodiments of the present disclosure. Wherein the terminal may be a variety of personal computers, notebook computers, smart phones, tablet computers, portable wearable devices, and so on.

The computer device may be a handwriting tablet 200 as shown in FIG. 2. The screen of the handwriting tablet 200 may be a touch screen, and the user can take notes on the handwriting tablet through a touch operation. The handwriting tablet 200 may also be equipped with an electromagnetic board and an electromagnetic pen, and the user can use the electromagnetic pen to take notes on the handwriting tablet 200. Specifically, the handwriting tablet 200 acquires a note page identification of the note page selected from the original notebook, reads a note page configuration file corresponding to the note page identification, parses the note page configuration file to obtain the handwritten contents of the note page corresponding to the note page identification and creates a new notebook based on the obtained handwritten contents of the note page.

The embodiments of the method for processing a note page of a notebook provided will be mainly described by using a computer device as the handwriting tablet in the present disclosure. It is to be appreciated that the computer device may also be other terminals, such as various personal computers, notebook computers, smart phones, tablet computer or portable wearable devices, etc.

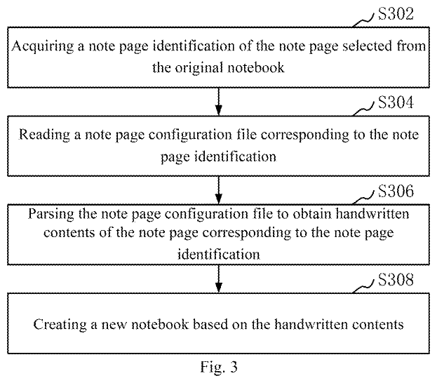

In one embodiment, as shown in FIG. 3, a method for processing a note page of a notebook is provided. By exemplifying the method applied to the handwriting tablet in FIG. 2, the method for processing a note page of a notebook includes the following steps.

Step S302, acquiring a note page identification of the note page selected from the original notebook

In the present embodiment, the handwriting tablet provides a function of reading electronic books. The notes written by the user in the read page can be separately saved as a single page, which is referred to as a note page. For multiple note pages in the same electronic book, the handwriting tablet will integrate them into a notebook corresponding to the electronic book, that is, the aforementioned original notebook. In addition, the handwriting tablet can also provide a note-taking function, which is independent of the reading of the electronic books. In this function, the user can newly create a notebook, which is the aforementioned original notebook and consists of at least one empty note page, and the user can write notes in the note page. In the present embodiment, the note page identification is a mark used to identify the note page, such as a page number. The page number refers to the number used to indicate the order of the note page in the original notebook.

Specifically, a virtual button may be provided in the original notebook, and the virtual button may be used to trigger a selection instruction for the note page. When the handwriting tablet detects that the virtual button in the original notebook is triggered, the selected instruction is acquired, and the corresponding note page is selected in the original notebook according to the selection instruction. When the handwriting tablet detects that at least one note page in the original notebook is selected, the note page identification of the note page selected from the original notebook is acquired. Further, the note page identification may be a page number, and the form of the page number may be a letter form, a number form, a symbol form, or the form of a combination thereof.

Step S304, reading a note page configuration file corresponding to the note page identification

The note page configuration file refers to a file that records the configuration information of the note page. Specifically, each note page has a corresponding note page configuration file, and the note page configuration file records the configuration information of the corresponding notebook. For example, the configuration information may be resource path, creation time, modification time, version of note, the size and coordinates of the inserted picture of the corresponding note page, the unique identification of the notebook, the note page identification, and the page size of each note page, etc. According to the note page identifications of the respective note pages selected from the original notebook, the handwriting tablet searches for the note page configuration file corresponding to each note page identification, and reads each note page configuration file that is found.

In one embodiment, each original notebook has a corresponding picture file, in which pictures included in the handwritten contents of all note pages in the original notebook, such as a note content pictures and a picture inserted in the note pages, are recorded.

The note content picture refers to a picture formed only for the user's note content part in the note page. Specifically, the picture path of all pictures in the respective original notebooks is recorded in the note page configuration file, and the corresponding picture can be found in the picture file according to the picture path. All the note pages of the original notebook share a picture file, and a picture that is repeatedly used in all note pages is only recorded once in the picture file, which avoids repeated recording of the picture.

In one embodiment, the note page configuration file may be an object notation file (JavaScript Object Notation, json file). Object notation is a lightweight data exchange format, which uses a text formal completely independent of programming language to store and represent data, is easy to read and write and also easy to parse and generate by a machine, and effectively improves network transmission efficiency. The object notation file in the present embodiment refers to a file that uses the lightweight data exchange format of the object notation to store data and represent data.

Step S306, parsing the note page configuration file to obtain handwritten contents of the note page corresponding to the note page identification

Specifically, the handwriting tablet can create an empty notebook, and copy the note page configuration files corresponding to the respective note page identifications into the empty notebook. In one manner, the handwriting tablet can create one empty notebook for each note page, or can also create one empty notebook for multiple selected note pages. The handwriting tablet parses all the note page configuration files copied into the empty notebook sequentially or simultaneously, to obtain the handwritten contents in the note pages corresponding to the respective note page configuration files. The handwritten contents in the note pages obtained by parsing include the page contents the read page in the corresponding electronic book and the note contents of the note page in the corresponding original notebook. The note contents include text inserted, pictures inserted and pictures drawn by the user in the read page of the corresponding electronic book etc.

In one embodiment, the copying the note page configuration files corresponding to the respective note page identifications into the created empty notebook includes: copying the note page configuration files corresponding to the respective note page identifications into the created empty notebook in sequence of the note page identifications corresponding to the respective notebook configuration files.

Step S308, creating a new notebook based on the handwritten contents

Specifically, the handwriting tablet copies the contents obtained by parsing the respective notebook configuration files into the created empty notebook to form a new notebook. Further, the contents copied into the created empty notebook include the page contents of the read page in the corresponding electronic book and the note contents of the note page in the corresponding original notebook. The respective note pages in the new notebook can be arranged in sequence of the note page identifications corresponding to the respective note pages.

In the method for processing a note page of a notebook described above, the note page configuration file corresponding to the note page identification of the selected note page in the original notebook is read, the note page configuration file is parsed to obtain the handwritten contents of the note page corresponding to the note page identification, and a new notebook is created according to the contents. By using the solution of the present disclosure, when part of the notes of a certain electronic book needs to be processed, a new notebook can be generated separately for the part of the note pages, which realizes the processing of part of the note pages of the notebook.

In one embodiment, the acquiring the note page identification of the note page selected from the original notebook includes: resenting thumbnails of note pages in response to a preset trigger operation for the original notebook; determining a thumbnail selected from the presented thumbnails by a touch operation; and acquiring the note page identification of the note page corresponding to the selected thumbnail.

The preset trigger operation is a operation set in advance to trigger the presentation of thumbnails corresponding to the respective note pages in the original notebook by the handwriting tablet. A thumbnail refers to a small image obtained by processing the note page by means of compression.

Specifically, the preset trigger operation may be a preset gesture, such as operations of drawing a circle in the note page or double-clicking a specific position in the note page. When the handwriting tablet detects a preset trigger operation for the original notebook, a selection instruction for a note page is triggered. The preset trigger operation may also be the operation of pressing a specific virtual button in the original notebook. When the virtual button is pressed, a selection instruction for a note page is triggered.

The handwriting tablet can pop up a new window or enter a new page according to the selection instruction, and in the new window or the new page, the thumbnails corresponding to the respective note pages in the original notebook are presented. The thumbnail selected from the thumbnails presented in the new window or the new page through a touch operation is determined, and the note page identification of the note page corresponding to the selected thumbnail is acquired.

In the present embodiment, a picture can be presented in the form of thumbnail, and the corresponding note page can be selected indirectly by means of selecting the thumbnail, which improves the efficiency of selecting the note page.

In one embodiment, the thumbnails corresponding to the respective note pages in the original notebook and presented by the handwriting tablet may include hyperlinks to the corresponding full-sized note pages. When the handwriting tablet detects that the thumbnail is triggered, the full-size note page corresponding to the thumbnail is presented.

In the present embodiment, the full-size note page corresponding to the thumbnail can be presented, so that the user can view the handwritten contents in the selected note page more intuitively, thereby avoiding the situation that the user selects the wrong note page due to the fact that the user is not clear about the specific handwritten contents of the note page.

In one embodiment, the reading the note page configuration file corresponding to the note page identification includes: reading a basic information file of the original notebook;

searching a file identification array of the basic information file for a file identification corresponding to the note page identification; reading the corresponding note page configuration file in accordance with the file identification.

The basic information file is a file containing a file identification array of the corresponding original notebook. The file identification array is an array containing the file identifications of all note pages in the corresponding original notebook. The file identification refers to the file identification of the note page configuration file corresponding to the note page of the original notebook.

Specifically, each note page in the original notebook has a corresponding note page configuration file, and each note page configuration file has a corresponding file identification.

The basic information file corresponding to each original notebook records the file identifications of all note page configuration files in the form of an array.

The handwriting tablet reads the basic information file of the original notebook, and can obtain the corresponding file identification array by parsing the basic information file. In the file identification array, the file identifications of all the note page configuration files are recorded in sequence of the note page identifications. By exemplifying the note page identification as a page number in a numerical form, the file identifications of all note page configuration files are recorded in the file identification array in sequence of the page numbers. For example, the first file identification in the file identification array is the file identification of the note page configuration file corresponding to the note page whose page number is “1”. After the corresponding file identification is found, the handwriting tablet can read the corresponding note page configuration files according to the respective found file identifications.

In the present embodiment, the file identification array can be obtained by parsing the basic information file, and the file identification corresponding to each note page identification can be quickly found in the array according to the respective note page identifications, and the corresponding note page configuration file is read according to the file identification, which improves the efficiency of finding the note page configuration file.

In one embodiment, the method for processing a note page of a notebook further includes: creating a new resource table; importing a picture identification of a picture resource of the selected note page in the original notebook into the new resource table; generating a number of citations of the picture resource in the new resource table, in accordance with the number of citations of the picture resource corresponding to the picture identification in the new notebook; when it is detected that the number of citations of the picture resource in the new notebook has changed, the number of citations of the picture resource is re-determined; the re-determined number of citations of the picture resource is updated in the new resource table.

The picture resource refers to the inserted picture or the content picture of the note page in the new notebook, which, of course, is not limited thereto, and for example may also include the text contents inserted into the note page. By exemplifying picture resources, the resource table refers to a table used to record the picture identifications and the number of citations of the picture resources cited in the corresponding notebook.

Specifically, the original notebook has a corresponding resource file, and the resource file includes a resource table corresponding to the picture resources in the original notebook, which may be referred as the original resource table. In the original resource table, the picture identifications and the number of citations of the picture resources cited in the original notebook are recorded. The handwriting tablet creates a new resource table dedicated to recording the picture identifications and the number of citations of the picture resources cited in the new notebook, determines a picture resource cited by the selected note page in the original notebook, imports the picture identification of the picture resource in the original resource table into the created new resource table, and generates the number of citations of the picture resource in the created new resource table according to the number of citations of the picture resource corresponding to the picture identification in the new notebook. The new resource table and the original resource table exist independently and do not affect each other.

When the handwriting tablet detects that a picture identification already exists in the new resource table, and the number of citations of the picture resource corresponding to the picture identification is increased or decreased in the new notebook, the number of citations of the picture resource is re-determined. The re-determined number of citations of the picture resource is updated in the new resource table.

Further, when the handwriting tablet detects that the picture identification already exists in the new resource table, and the number of citations of the picture resource corresponding to the picture identification is increased in the new notebook, the magnitude of increase in the number of citations of the picture resource is determined, the number of citations of the picture resource is re-determined according to the magnitude of increase, and the re-determined number of citations of the picture resource is updated in the new resource table. When the handwriting tablet detects that the picture identification already exists in the new resource table, and the number of citations of the picture resource corresponding to the picture identification is decreased in the new notebook, the magnitude of decrease in the number of citations of the picture resource is determined, the number of citations of the picture resource is re-determine according to the magnitude of decrease, and the re-determined number of citations of the picture resource updated in the new resource table.

In the present embodiment, a new resource table that is independent of the original resource table each other is created for the new notebook, so that the new resource table and the original resource table do not affect each other, thereby avoiding the number of citations of the picture resource from being recorded in disorder. In one embodiment, when the handwriting tablet detects that the picture inserted in the new notebook is not recorded in the new resource table, the picture identification and the number of citations of the picture are correspondingly generated in the new resource table. When the handwriting tablet detects that the number of citations of at least one picture resource in the new resource table is 0, the record of the picture resource whose number of citations is 0 will be deleted in the new resource table.

In the present embodiment, as the picture resources in the new notebook change, the new resource table can correspondingly increase the records of the picture identifications and the number of citations of the picture resource and correspondingly delete the records of unused picture resources, thereby improving the adjustability of the records of the respective picture resources in the new resource table.

In one embodiment, the method for processing a note page of a notebook further includes: determining a partial selection area in the note page based on a partial selection instruction, in case that the partial selection instruction for the note page in the original notebook or the new notebook is detected; obtaining partial handwritten contents in the partial selection area; generating a new note page based on the partial handwritten contents.

The partial selection instruction is an instruction used to select a partial area of the note page. The partial selection area is the part of the area that needs to be selected in the note page. The note data is data with note contents.

Specifically, the handwriting tablet may be preset with a gesture for triggering a partial selection instruction, such as a circle selection in a note page. When the handwriting tablet detects a partial selection instruction for a note page in the original notebook or the new notebook, a partial selection area in the corresponding note page is determined according to the partial selection instruction. The partial selection area can be of a closed or approximately closed circular or rectangular shape and other shapes.

The handwriting tablet searches the handwritten contents of the corresponding note page for the partial handwritten contents according to the position of the partial selection area in the corresponding note page and the range of the note page contained in the partial selection area. A target range can be determined according to two items of the partial handwritten contents of the first item of the obtained partial handwritten contents and the last item of the obtained partial handwritten contents, and a new notebook is generated according to the handwritten contents of the note page contained in the target range.

In the present embodiment, when a part of the handwritten contents in a certain note page needs to be processed, a new note page can be formed for the part of the handwritten contents in the note page, and only the new note page needs to be processed, which realizes processing of part of the handwritten contents of the note page.

In one embodiment, the method for processing a note page of a notebook further includes: determining a note page adjustment type corresponding to a note page adjustment instruction, in response to the note page adjustment instruction for the new notebook, wherein there are a plurality of note page adjustment types, the plurality of note page adjustment types comprise at least one of: a type of adjusting the handwritten contents in the note page and a type of adjusting an order of the note pages; adjusting the note pages in the new notebook based on the note page adjustment type; updating the note pages in the original notebook synchronously in accordance with the adjusted note pages in the new notebook.

The note page adjustment instruction is an instruction used to adjust the note page. Specifically, when the handwriting tablet detects a note page adjustment instruction for a new notebook, the note page adjustment type corresponding to the note page adjustment instruction is determined. When the note page adjustment type is a type of adjusting the handwritten contents in the note page, the handwriting tablet adjusts the handwritten contents in the corresponding note page according to the adjustment type. When the note page adjustment type is a type of adjusting the order of the note pages, the handwriting tablet adjusts the order of the corresponding note pages in the new notebook according to the adjustment type. The note page in the original notebook, which corresponds to the adjusted note page in the new notebook, is determined, and the corresponding note page in the original notebook is updated synchronously according to the adjusted note page in the new notebook. In the present embodiment, after a new notebook is generated, the order and the handwritten contents of the note pages in the new notebook can be adjusted, and the corresponding note pages in the original notebook can be updated synchronously according to the adjusted note pages, and the user does not needs to adjust again the corresponding note pages in the original notebook with the same manual operations, which improves the efficiency of adjusting the note pages.

In one embodiment, when the handwriting tablet detects that at least one note page in the original notebook is updated synchronously according to the adjusted note page in the new notebook, the picture resource of the updated note page in the original notebook is detected.

When it is detected that the number of citations of the picture resource in the updated note page in the original notebook has changed, the number of citations of the picture resource in the original notebook is re-determined. The re-determined number of citations of the picture resource is updated synchronously in the original resource table.

In the present embodiment, when the note page in the original notebook is updated synchronously with the note page in the new notebook, if the number of citations of the picture resource in the original notebook has changed, the original resource table of the original notebook is also updated synchronously, thereby avoiding the number of citations of the picture resource from being recorded in disorder.

In one embodiment, when the handwriting tablet detects that the picture inserted in the original notebook is not recorded in the original resource table, the picture identification and the number of citations of the picture are correspondingly generated in the original resource table. When the handwriting tablet detects that the number of citations of at least one picture resource in the original resource table is 0, the record of the picture resource whose number of citations is 0 will be deleted in the original resource table.

In the present embodiment, as the picture resources in the original notebook change, the original resource table can correspondingly increase the records of the picture identifications and the number of citations of the picture resource and correspondingly delete the records of unused picture resources, thereby improving the adjustability of the records of the respective picture resources in the original resource table.

In one embodiment, before the new notebook is shared to other terminals, at least one of the order and the handwritten contents of the note pages in the new notebook can also be adjusted. When the handwriting tablet detects that at least one of the order and the handwritten contents in the new note pages has been adjusted, a target user identification will be acquired, and the adjusted new notebook is sent to the terminal corresponding to the target user identification.

In the present embodiment, before the new notebook is shared to other terminals, the note pages in the new notebook can be adjusted first, and then the adjusted note pages can be shared to other terminals.

In one embodiment, when the handwriting tablet detects that at least one of the order and the handwritten contents of the note pages has been adjusted before the new notebook is shared to other terminals, a synchronous update option can be displayed. When it is detected that the synchronous update option is confirmed, the corresponding note page in the new notebook is updated according to the adjusted note page.

In the present embodiment, if the handwriting tablet detects that the note page in the new notebook has been adjusted before the new notebook is shared to other terminals, the corresponding note page in the new notebook can be synchronously updated according to the adjusted note page, and the user does not need to adjust the note pages in the new notebook through the same manual operations again, which improves the adjustment efficiency of the note pages.

In one embodiment, the method for processing a note page of a notebook further includes: converting at least one note page in the original notebook or the new notebook into a picture, and configuring the picture as a screensaver picture in response to a screensaver setting instruction for the picture; or converting a plurality of note pages in the original notebook or the new notebook into a picture sequence, and sequentially configuring pictures in the picture sequence as screensaver pictures in accordance with a preset cycle; or recognizing handwritten contents in the original notebook or the new notebook, extracting drawing contents in the handwritten contents, converting the drawing contents into a note page, and converting the note page into a screensaver picture.

The picture sequence is a picture formed by arranging multiple pictures in order.

Specifically, the handwriting tablet can directly convert one note page in the original notebook or the new notebook into one picture, or can also convert multiple note pages in the original notebook or the new notebook into one picture. When a screen saver setting instruction for the picture is detected, the picture can be configured as a screen saver picture, and the screen saver picture can be stored in a screen saver directory.

Alternatively, the handwriting tablet can convert multiple note pages in the original notebook or the new notebook into a picture sequence, and store the picture sequence in the screen saver directory. The respective pictures in the picture sequence will be configured as screen saver pictures in sequence according to a preset cycle. By exemplifying a preset period from Monday to Friday, in the order from Monday to Friday, the respective pictures in the picture sequence are configured as screen saver pictures in sequence. For example, the screen saver picture on Monday is the first picture in the picture sequence, the screen saver picture on Tuesday is the second picture in the picture sequence, and the screen saver picture on Wednesday is the third picture in the picture sequence, . . . . According to this order, the pictures in the picture sequence are set as the screen saver pictures circularly.

Alternatively, the handwriting tablet can recognize the note contents in the original notebook or the new notebook, extract at least one drawing content in the note contents, convert the extracted drawing content into a separate note page, and convert the separate note page into a screen saver picture. For example, the extracted drawing content in the note contents is a duck drawn by the user, then the duck drawn by the user is converted into a separate note page, the separate note page is converted into a screen saver picture of a duck, and the screen saver picture is stored in the screen saver directory.

In the present embodiment, the note page in the original notebook or the new notebook can be set as a screen saver, so that the user can view the note page more quickly.

In one embodiment, the method for processing a note page of a notebook further includes: acquiring a sharing instruction; determining a target user identification in response to the sharing instruction; sending the new notebook to a terminal corresponding to the target user identification.

Specifically, a virtual button for sharing may be provided in the new notebook, and when the handwriting tablet detects that the virtual button is triggered, a sharing instruction is acquired. In response to the sharing instruction, when the handwriting tablet detects at least one user identification selected from a contact list through a touch operation, the selected user identification in the contact list is determined as the target user identification. The handwriting tablet sends the new notebook to the terminal corresponding to the target user identification. The terminal corresponding to the target user identification may be various personal computers, notebook computers, smart phones, handwriting tablets, tablet computers, portable wearable devices, and so on.

In the present embodiment, when part of the note pages of a certain electronic book needs to be shared, because a new notebook is generated separately for the part of the note pages that need to be processed, only the new notebook needs to be shared to other terminals, which realizes sharing of part of the notebook.

In one embodiment, each new notebook shares one picture file with the corresponding original notebook, and in the picture file, the pictures contained in the handwritten contents of all the note pages in the new notebook and the corresponding original notebook are recorded. All note pages in each new notebook and the corresponding original notebook share one picture file, and the pictures that arc repeatedly used in all note pages are only recorded once in the picture file, which avoids repeated recording of pictures.

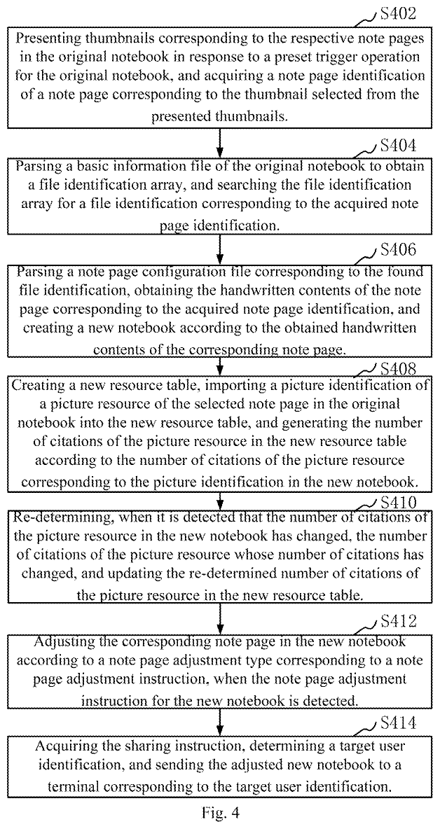

In one specific embodiment, as shown in FIG. 4, the method for processing a note page of a notebook provided by the embodiment of the present disclosure may include the following steps.

S402, presenting thumbnails corresponding to the respective note pages in the original notebook in response to a preset trigger operation for the original notebook, and acquiring a note page identification of a note page corresponding to the thumbnail selected from the presented thumbnails.

S404, parsing a basic information file of the original notebook to obtain a file identification array, and searching the file identification array for a file identification corresponding to the acquired note page identification.

S406, parsing a note page configuration file corresponding to the found file identification, obtaining the handwritten contents of the note page corresponding to the acquired note page identification, and creating a new notebook according to the obtained handwritten contents of the corresponding note page.

S408, creating a new resource table, importing a picture identification of a picture resource of the selected note page in the original notebook into the new resource table, and generating the number of citations of the picture resource in the new resource table according to the number of citations of the picture resource corresponding to the picture identification in the new notebook.

S410, re-determining, when it is detected that the number of citations of the picture resource in the new notebook has changed, the number of citations of the picture resource, whose number of citations has changed, and updating the re-determined number of citations of the picture resource in the new resource table.

S412, adjusting the corresponding note page in the new notebook according to a note page adjustment type corresponding to a note page adjustment instruction, when the note page adjustment instruction for the new notebook is detected.

S414, acquiring the sharing instruction, determining a target user identification, and sending the adjusted new notebook to a terminal corresponding to the target user identification.

It should be appreciated that although the various steps in the flowcharts of FIGS. 3 and 4 are displayed in sequence as indicated by the arrows, these steps are not necessarily performed in the order indicated by the arrows. Unless indicated explicitly herein, there is no strict limitation on the order for execution of these steps, and these steps can be executed in other orders. Moreover, at least part of the steps in FIGS. 3 and 4 may include multiple sub-steps or multiple stages, and these sub-steps or stages are not necessarily executed and completed at the same time, but can be executed at different moments, and the order for execution of these sub-steps or stages are also not necessarily performed sequentially, but may be executed in turn or alternately to other steps or at least a part of sub-steps or stages of other steps.

In one implementation, the user can select one or several pages of notes from the notebook to share with friends. The handwriting tablet displays a note page selection page, in which icons of all created notebooks (i.e. the above-described original notebook) are arranged and displayed. After the icon of a certain notebook is selected, a note page thumbnail interface of the notebook can be further displayed for the user to select a note page. After the note page selected by the user is determined, the note page is generated as a new notebook according to the flow of the above-described method, a sharing interface is displayed, and the new notebook is shared with the friends of the user according to the operation of the user. In one implementation, the user can freely combine the note pages in multiple notebooks. The handwriting tablet displays the note page selection page, in which icons of all created notebooks (i.e. the above-described original notebook) are arranged and displayed. After the icon of a certain notebook is selected, the note page thumbnail interface of the notebook can be further displayed for the user to select note pages. After the note pages selected by the user are determined, the note pages are generated as a new notebook according to the flow of the above-described method, and the handwriting tablet acquiesces in determining the order of the page numbers of the respective note pages in the new notebook according to the order for selecting the note pages. After the notebook is generated, a notebook editing function is provided to the user through an edit control, and the function includes adjusting the order of the page numbers of the note pages and editing the handwritten contents of the currently displayed note pages (such as erasing the original notes, continuing to write the note, etc.).

In one implementation, the user can select one or several pages of notes from the notebook to set as the screen saver. The handwriting tablet displays the note page selection page, in which icons of all created notebooks (i.e. the above-described original notebook) are arranged and displayed. After the icon of a certain notebook is selected, the note page thumbnail interface of the notebook can be further displayed for the user to select a note page. After the note page selected by the user is determined, the note page is generated as a new notebook according to the flow of the above-described method, then the handwritten contents of the note page in the notebook is generated as a picture, and the picture is saved under the storage path of screen saver pictures in the system, so that the handwriting tablet automatically retrieves the picture for presentation on the screen saver.

In the above-described manners, the newly generated notebook will be presented in the notebook interface together with the original notebook. In addition, in the manners of selecting the note page, the respective above-described manners provide the user with a selection entry in the form of a thumbnail of the note page. In practical applications, the user can also be provided a selection entry in the process of browsing the note page in the notebook.

For example, for the currently presented note page, a selection control can be added in the toolbar. When the control is clicked, the selection operation for the currently displayed note page will be completed.

In one embodiment, a computer device is provided. The computer device may be a terminal, and its internal structure diagram may be as shown in FIG. 1. The computer device includes a processor, a memory, a network interface, a display screen and an input device, which are connected through a system bus. The processor of the computer device is used to provide calculation and control capabilities. The memory of the computer device includes a non-volatile storage medium and an internal memory. An operating system and a computer program are stored in the non-volatile storage medium. The internal memory provides an environment for the operation of the operating system and the computer program in the non-volatile storage medium. The network interface of the computer device is used to communicate with an external terminal through a network connection. The computer program, when executed by the processor, implements the method for processing a note page of a notebook provided in any embodiment of the present disclosure. The display screen of the computer device can be a liquid crystal display screen or an electronic ink display screen, and the input device of the computer device can be a touch layer covered on the display screen, or can also be a button, a trackball or a touchpad provided on the shell of the computer device, or can also be an external keyboard, touchpad, or mouse.

It is to be appreciated by those skilled in the art that the structure shown in FIG. 1 is only a block diagram of a part of the structure related to the solution of the present disclosure, and does not constitute a limitation on the computer device, to which the solution of the present disclosure is applied. The specific computer device may include more or less components than shown in the figure, or combine some components, or have a different arrangement of components.

It is to be appreciated by those ordinary skilled in the art that all or part of the flow in the method for processing a note page of a notebook provided by the foregoing respective embodiments can be implemented by instructing relevant hardware through a computer program, and the described computer program can be stored in a non-volatile computer readable storage medium, and the computer program, when executed, may include the flow of the method for processing a note page of a notebook provided in the foregoing respective embodiments. Wherein any reference to memory, storage, database or other media used in the respective embodiments of the present disclosure may include at least one of non-volatile and volatile memory. The non-volatile memory may include read only memory (ROM), programmable ROM (PROM), electrically programmable ROM (EPROM), electrically erasable and programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM), etc.

The respective technical features of the above embodiments can be combined arbitrarily. In order to make the description concise, all possible combinations of the respective technical features in the above-described embodiments are not described. However, as long as there is no contradiction in the combinations of these technical features, they should be considered as falling in the range described in this specification.

The above-described embodiments only express several implementations of the present disclosure, and the description thereof is relatively specific and detailed, but should not be thus construed as limiting the scope of the disclosed patent. It should be pointed out that for those of ordinary skill in the art, without departing from the concept of the present disclosure, several modifications and improvements can also be made, and these all fall within the protection scope of the present disclosure. Therefore, the protection scope of the patent of the present disclosure should be defined by the appended claims.

1. A method for processing a note page of a notebook, comprising:
acquiring a note page identification of the note page selected from an original notebook;
reading a note page configuration file corresponding to the note page identification;
parsing the note page configuration file to obtain handwritten contents of the note page corresponding to the note page identification; and
creating a new notebook based on the handwritten contents.

2. The method according to claim 1, wherein the acquiring a note page identification of the note page selected from an original notebook comprises:
presenting thumbnails of note pages in response to a preset trigger operation for the original notebook;
determining a thumbnail selected from the presented thumbnails by a touch operation; and
acquiring the note page identification of the note page corresponding to the selected thumbnail.

3. The method according to claim 1 or 2, wherein the reading a note page configuration file corresponding to the note page identification comprises:
reading a basic information file of the original notebook;
searching a file identification array of the basic information file for a file identification corresponding to the note page identification; and
reading the note page configuration file based on the file identification.

4. The method according to claim 1, wherein the method further comprises:
creating a new resource table;
importing a picture identification of a picture resource of the note page into the new resource table;
generating a number of citations of the picture resource in the new resource table, in accordance with the number of citations of the picture resource corresponding to the picture identification in the new notebook.

5. The method according to claim 1, wherein the method further comprises:
determining a partial selection area in the note page based on a partial selection instruction, in case that the partial selection instruction for the note page in the original notebook or the new notebook is detected;
obtaining partial handwritten contents in the partial selection area; and
generating a new note page based on the partial handwritten contents.

6. The method according to claim 1, wherein the method further comprises:
determining a note page adjustment type corresponding to a note page adjustment instruction, in response to the note page adjustment instruction for the new notebook, wherein there are a plurality of note page adjustment types, the plurality of note page adjustment types comprise at least one of: a type of adjusting the handwritten contents in the note page and a type of adjusting an order of the note pages;
adjusting the note pages in the new notebook based on the note page adjustment type;
updating the note pages in the original notebook synchronously in accordance with the adjusted note pages in the new notebook.

7. The method according to claim 1, wherein the method further comprises:
converting at least one note page in the original notebook or the new notebook into a picture, and configuring the picture as a screen saver picture in response to a screen saver setting instruction for the picture; or
converting a plurality of note pages in the original notebook or the new notebook into a picture sequence, and sequentially configuring pictures in the picture sequence as screen saver pictures in accordance with a preset cycle; or
recognizing handwritten contents in the original notebook or the new notebook, extracting drawing contents in the handwritten contents, converting the drawing contents into a note page, and converting the note page into a screen saver picture.

8. The method according to claim 1, wherein the method further comprises:
acquiring a sharing instruction;
determining a target user identification in response to the sharing instruction;
sending the new notebook to a terminal corresponding to the target user identification.

9. A computer device, comprising:
at least one processor; and
at least one memory, the at least one memory storing executable instructions that upon execution cause the at least one processor to perform operations, the operations comprising:
acquiring a note page identification of the note page selected from an original notebook;
reading a note page configuration file corresponding to the note page identification;
parsing the note page configuration file to obtain handwritten contents of the note page corresponding to the note page identification; and
creating a new notebook based on the handwritten contents.

10. The computer device according to claim 9, wherein the operations further comprise:
presenting thumbnails of note pages in response to a preset trigger operation for the original notebook;
determining a thumbnail selected from the presented thumbnails by a touch operation; and
acquiring the note page identification of the note page corresponding to the selected thumbnail.

11. The computer device according to claim 9, wherein the operations further comprise:
reading a basic information file of the original notebook;
searching a file identification array of the basic information file for a file identification corresponding to the note page identification; and
reading the note page configuration file based on the file identification.

12. The computer device according to claim 9, wherein the operations further comprise:
creating a new resource table;
importing a picture identification of a picture resource of the note page into the new resource table; and
generating a number of citations of the picture resource in the new resource table, in accordance with the number of citations of the picture resource corresponding to the picture identification in the new notebook.

13. The computer device according to claim 9, wherein the operations further comprise:
determining a partial selection area in the note page based on a partial selection instruction, in case that the partial selection instruction for the note page in the original notebook or the new notebook is detected;
obtaining partial handwritten contents in the partial selection area; and
generating a new note page based on the partial handwritten contents.

14. The computer device according to claim 9, wherein the operations further comprise:
determining a note page adjustment type corresponding to a note page adjustment instruction, in response to the note page adjustment instruction for the new notebook, wherein there are a plurality of note page adjustment types, the plurality of note page adjustment types comprise at least one of: a type of adjusting the handwritten contents in the note page and a type of adjusting an order of the note pages;
adjusting the note pages in the new notebook based on the note page adjustment type; and
updating the note pages in the original notebook synchronously in accordance with the adjusted note pages in the new notebook.

15. The computer device according to claim 9, wherein the operations further comprise:
converting at least one note page in the original notebook or the new notebook into a picture, and configuring the picture as a screen saver picture in response to a screen saver setting instruction for the picture; or
converting a plurality of note pages in the original notebook or the new notebook into a picture sequence, and sequentially configuring pictures in the picture sequence as screen saver pictures in accordance with a preset cycle; or
recognizing handwritten contents in the original notebook or the new notebook, extracting drawing contents in the handwritten contents, converting the drawing contents into a note page, and converting the note page into a screen saver picture.

16. The computer device according to claim 9, wherein the operations further comprise:
acquiring a sharing instruction;
determining a target user identification in response to the sharing instruction; and
sending the new notebook to a terminal corresponding to the target user identification.

17. A non-transitory computer readable storage medium, storing executable instructions that upon execution cause a processor to perform operations comprising:
acquiring a note page identification of the note page selected from an original notebook;
reading a note page configuration file corresponding to the note page identification;
parsing the note page configuration file to obtain handwritten contents of the note page corresponding to the note page identification; and
creating a new notebook based on the handwritten contents.

18. (canceled)

19. The non-transitory computer readable storage medium according to claim 17, wherein the operations further comprise:
presenting thumbnails of note pages in response to a preset trigger operation for the original notebook;
determining a thumbnail selected from the presented thumbnails by a touch operation; and
acquiring the note page identification of the note page corresponding to the selected thumbnail.

20. The non-transitory computer readable storage medium according to claim 17, wherein the operations further comprise:
reading a basic information file of the original notebook;
searching a file identification array of the basic information file for a file identification corresponding to the note page identification; and
reading the note page configuration file based on the file identification.

21. The non-transitory computer readable storage medium according to claim 17, wherein the operations further comprise:
creating a new resource table;
importing a picture identification of a picture resource of the note page into the new resource table; and
generating a number of citations of the picture resource in the new resource table, in accordance with the number of citations of the picture resource corresponding to the picture identification in the new notebook.
